(19) United States
(12) Patent Application Publication
(10) Pub. No.: US 2014/0122300 A1
(43) Pub. Date: May 1, 2014

(54) Retail Website User Interface

(71) Applicant: Target Brands, Inc., Minneapolis, MN (US)

(72) Inventors: Michael F. Gonsalves, Minneapolis, MN (US); Gregory M. Nations, Minneapolis, MN (US); Chad R. Gourley, Elk River, MN (US); Patricia Korth-McDonnell, Brooklyn, NY (US); Sarah E. Schoeffler, Minneapolis, MN (US); Joe Stewart, Brooklyn, NY (US)

(73) Assignee: Target Brands, Inc., Minneapolis, MN (US)

(21) Appl. No.: 14/148,598

(22) Filed: Jan. 6, 2014

Related U.S. Application Data
(62) Division of application No. 12/887,098, filed on Sep. 21, 2010.

(51) Int. Cl. G06Q 30/06

(52) U.S. Cl. CPC G06Q 30/0625
USPC 705/26.62

(57) ABSTRACT

In one embodiment, a web page presented to a user includes a header section that substantially spans the top of the web page and provides a menu of selectable options as well as a search input box. A product display region provided below the header displays images and information about a selected product. Below the product display region is a carousel control that shows information about other products in a horizontally scrollable list. Two columns of various types of product review information provided by sources such as professional reviewers, existing owners, and the user's friends are displayed below the carousel control. Below the review information, a sortable and filterable grid of products is displayed such that the user's attention is drawn to the variety of products available for purchase.

### SUMMARY

In one embodiment, a web page presented to a user includes a header section that substantially spans the top of the web page and provides a menu of selectable options as well as a search input box. A product display region provided below the header displays images and information about a selected product. Below the product display region is a carousel control that shows information about other products in a horizontally scrollable list. Two columns of various types of product review information provided by sources such as professional reviewers, existing owners, and the user's friends are displayed below the carousel control. Below the review information, a sortable and filterable grid of products is displayed such that the user's attention is drawn to the variety of products available for purchase.

In some embodiments, image thumbnails or other displayed elements are at least partly superimposed with one or more label elements that display additional information about the pictured items. Similarly, the number of items the user currently has selected for purchase is indicated by a label associated with an image of a shopping cart, shopping bag, or other visual cue that represents the list of items the user intends to buy.

In another embodiment, an Internet web page is laid out with a header substantially spanning the top of the web page with product category-related information directly below it. In some implementations, the product category-related information provides images and shopping advice to help the user make an informed purchase. The product category-related information also includes a tri-column region in which professional advice, in the form of text, images, and multimedia, as well a collection of ranked rated products is displayed. Below the tri-column region is displayed a sorted and filtered array of selectable products shown as image thumbnails and associated textual information.

In another embodiment, an Internet web page has a header that substantially spans the top of the web page and including a menu bar and a search string input box. A personalized region is located directly below the header to display personalized greetings and information based upon the identity of a user. A collage of subregions is located below the personalized region, wherein each of the subregions optionally display marketing messages.

In yet another embodiment, an Internet web page has a page header region that includes a search string input box and a menu bar. The menu bar includes a collection of menu items that are associated with an associated drop down submenu, wherein the drop down submenu is displayed when the corresponding one of the collection of menu items is activated by a user. In some implementations, the drop down submenus include images and marketing information in addition to a collection of selectable submenu items.

In a further embodiment, an Internet web page has a page header region including a search string input box and one or more recommended searches. A search results region below the page header region displays one or more search results and one or more links to additional resources related to the search query input into the search string input box. A search narrowing region below the page header region displays one or more controls providing the user with options of narrowing the search results. In some examples, the controls are selectable to narrow the search results by product category, product price, product size, and product color.

The details of one or more embodiments are set forth in the accompanying drawings and the description below. Other features and advantages will be apparent from the description and drawings, and from the claims.

### DESCRIPTION OF DRAWINGS

This document describes these and other aspects in detail with reference to the following drawings.

FIGS. 1A, 1B, and 1C show three views of an example retail web page.

FIGS. 2A and 2B show two views of another example retail web page.

FIG. 3 shows an example of a personalized retail web page.

FIG. 4 shows an example retail web page header section.

FIG. 5 shows another view of an example retail web page.

### DETAILED DESCRIPTION OF ILLUSTRATIVE EMBODIMENTS

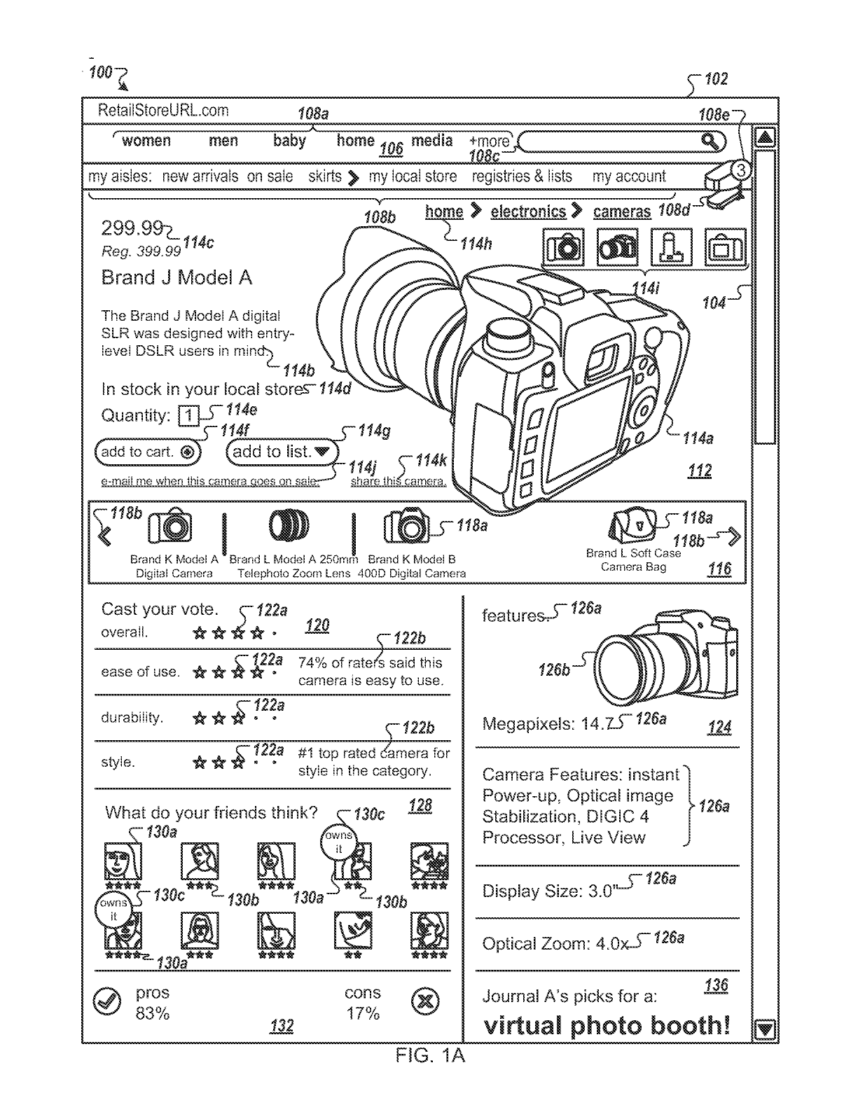

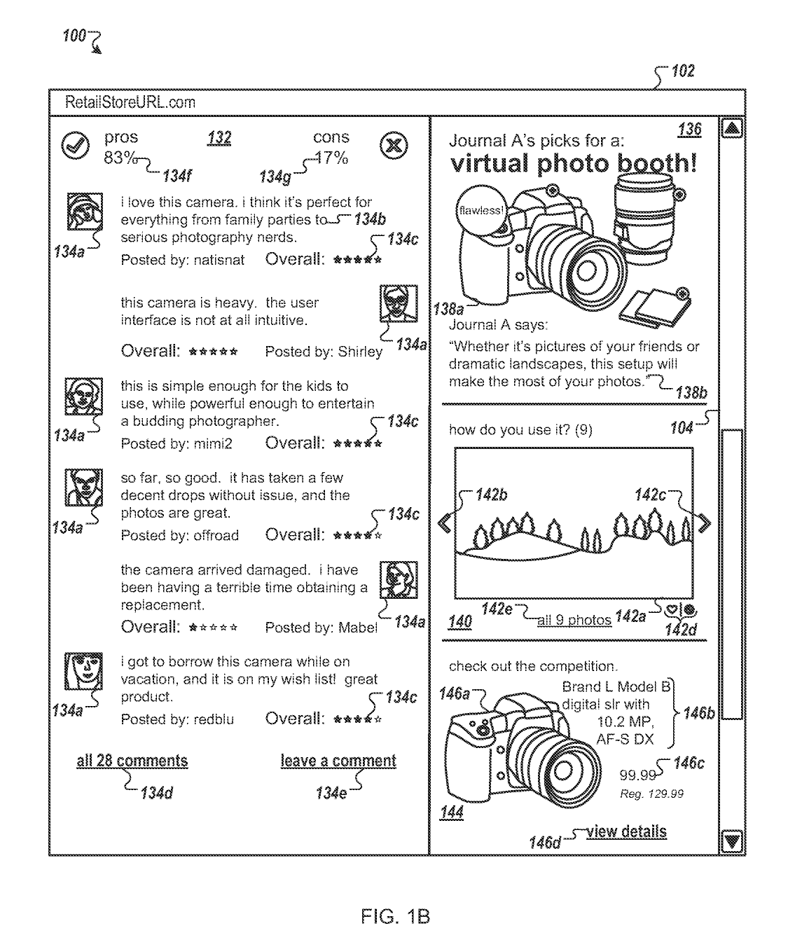

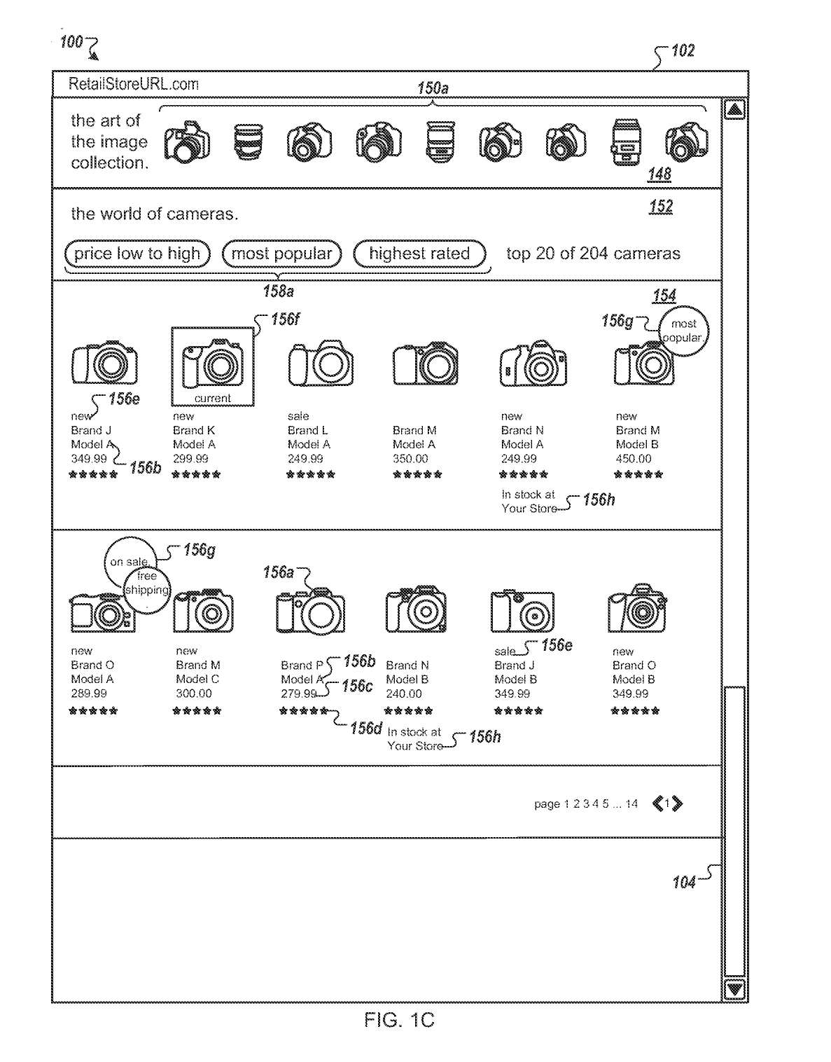

Referring to FIG. 1A, an example web page 100 is displayed in a window 102 of a screen (e.g., a computer monitor, a smartphone display, a television). In general, the web page 100 is laid out to be substantially the width of the window 102 and extends vertically. In some implementations, the web page 100 includes more information than can be conveniently displayed on the window 102 at one time. For example, a user interacts with a scroll bar 104 to shift the view of the web page 100 vertically. As can be seen in FIGS. 1A-1C, the scroll bar 104 is illustrated in three different positions, corresponding to three different vertically located views of the web page 100.

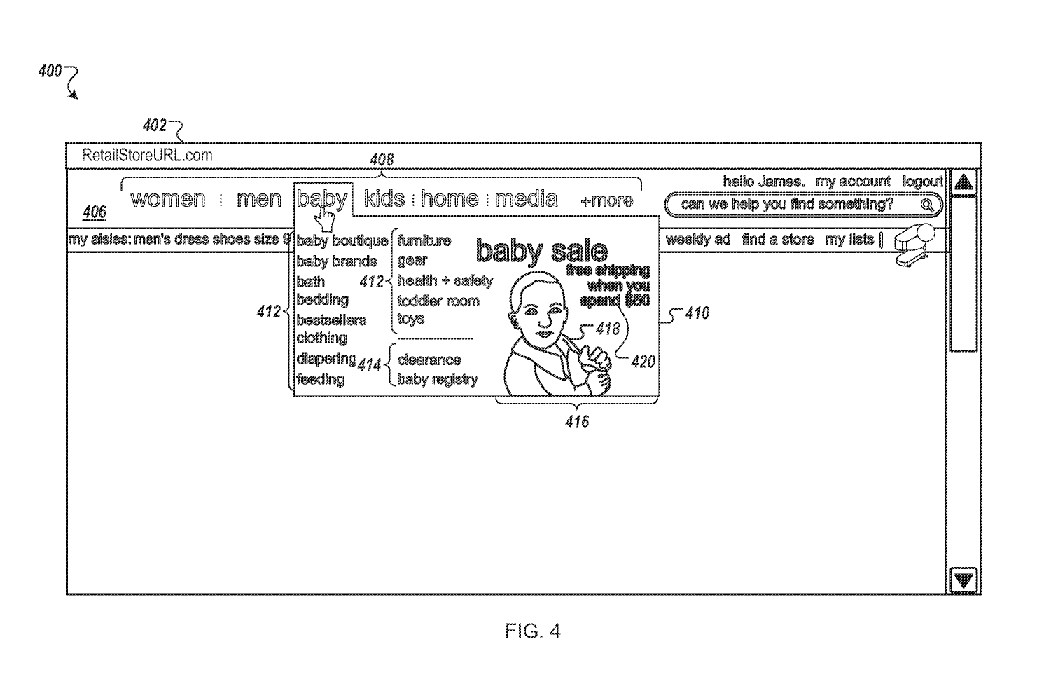

The web page 100 includes a page header 106 substantially spanning the width of the web page 100. The page header 106 includes a collection of menu items 108a and a collection of menu items 108b. In some implementations, the user selects the menu items 108a-108b to link to other web pages or to activate the display of submenu items. An example submenu will be discussed in the description of FIG. 4.

A search input box 108c is provided for users to enter search strings. For example, the user could type in keywords associated with a product he or she is seeking (e.g., “blue jeans”, “frozen pizza”, “batteries”) to activate a search routine that helps the user find what he or she is shopping for.

A shopping cart indicator 108d is selected by the user to display a list of items the user has already selected to purchase. A quantity indicator 108e is superimposed on the shopping cart indicator 108d. The quantity indicator 108e displays the quantity of items that the user has already selected for purchase (e.g., how many items are in the user's virtual shopping cart or bag). In some implementations, the quantity indicator 108e is displayed only when the user has selected one or more items for purchase (e.g., displayed only when the virtual shopping bag has something in it).

Below the page header 106 is a product display region 112. The product display region 112 provides information that depicts and describes a selected product. The product display region 112 includes a selected product image 114a, a selected product description 114b, a selected product price 114c, a selected product availability indicator 114d, and a desired quantity input box 114e. An add to cart button 114f, when activated, causes the desired quantity of the selected product to be added to the user's shopping cart. An add to list button 114g, when activated, causes the desired quantity of the selected product to be added to a shopping list.

A hierarchical list 114h displays a hierarchy of the categories in which the selected product has been organized within the range of products available through the web page 100. A collection of image thumbnails 114i display alternative views of the selected product.

An email link 114j, when selected, sets an indication that the user wishes to receive an email notification when the selected product goes on sale. A sharing link 114k, when selected, causes additional user interface elements to appear that provide the user an ability to share information about the selected product (e.g., email information to a friend, post information to a blog, post information to a social network).

A product carousel region 116 includes a collection of image thumbnails and product names 118a. In some implementations, the image thumbnails and product names 118a represent other products in the same product category as the selected product. For example, the selected product in this example is a camera, and the product carousel 116 includes other makes or models of cameras, product-specific accessories (compatible lenses or flash units), non-product specific accessories (e.g., bags, memory cards, batteries), or other products. A pair of arrow controls 118b, when activated, cause the product carousel 116 to shift the collection of image thumbnails and product names 118a to the left or right in order to display additional product selections.

A voting region 120 provides a collection of ratings controls 122a that the user manipulates to provide opinions about the selected product in various categories (e.g., overall, ease of use, durability, style). Statistical elements 122b optionally display statistical information about the selected product as rated by a larger population of voters (e.g., popularity rank, exceptionally high or low ratings in a particular category).

A features region 124 includes textual information 126a as well as an image 126b of the selected product. For example, the textual information 126a provides information about the selected product's physical attributes (e.g., size, weight) or capabilities (e.g., in the example of a camera, zoom power, resolution, color display).

A friends region 128 displays an array of thumbnails 130a. Each of the thumbnails 130a represents a friend of the user. In some implementations, the array of thumbnails 130a includes those friends of the user who have expressed a rating or other opinion of the selected product. In some implementations, the friends represented by the thumbnails 103a are persons associated with the user through a social networking service (e.g., Facebook by Facebook, Inc. of Palo Alto, Calif., MySpace by News Corp. Digital Media of Beverly Hills, Calif.), or a contact list (e.g., email addresses, instant messenger contacts). Associated with each of the thumbnails 103a is a rating indicator 103b. The rating indicator 103b displays the friend's rating of the selected product. A balloon indicator 130c is partly superimposed over none, some, or all of the thumbnails 103a to display additional information. For example, the balloon indicator 130c displays “owns it” for friends who have indicated that they own the selected product.

Referring to FIG. 1B, a comments region 132 includes a collection of customer comments. Each customer comment includes a photo thumbnail 134a, a comment block 134b, and a rating indicator 134c associated with a customer. For example, when a customer chooses to leave a comment and rating for the selected product, other shoppers see the customer's image, comment, and rating when looking at the same selected product. A link 134d, when selected, causes all customer comments associated with the selected product to be displayed. A link 134e, when selected, causes an interface to be displayed in which the user can leave a comment about the selected product. A percentage indicator 134f displays a percentage representing the number of customers who have given the selected product a favorable rating, while a percentage indicator 134g displays a percentage representing the number of customers who have given the selected product an unfavorable rating.

A professional review region 136 displays information obtained from professional reviews of the selected product, including a collection of images 138a and a text block 138b in which the reviewers' photos and comments about the selected product are displayed.

Usage region 140 displays images, such as an image 142a, that depict the selected product in use (e.g., photos taken with a selected camera, a selected sweater being modeled, a selected baseball bat being played with). A rewind control 142b and an advance control 142c, when selected, cause the previous or next photo in a collection of images to be displayed as the image 142a. A preference control 142d, when selected, lets the user indicate whether he or she likes or dislikes the image 142a. A link 142e, when selected, causes all the images in the collection of images to be displayed.

A competing product region 144 displays information about a product that is a marketplace competitor to the selected product. The information includes an image 146a, a quick description block 146b, a price indicator 146c, and a link 146d to view more details about the competing product. In some implementations, by selecting the link 146d, the competing product becomes the selected product in the web page 100.

A featured collection region 148 displays a collection of image thumbnails 150a for featured products in substantially the same category as the selected product.

A product selection region 152 and a product browsing region 154 provide controls that allow the user to look at substantially all of the products available in the selected product's category. The product browsing region 154 displays an array of product images 156a, product descriptions 156b, prices 156c, and ratings indicators 156d. Some of the product descriptions 156b include an additional information indicator 156e. For example, products that have recently been added to the collection display words or phrases such as “new” or “just arrived” as the additional information indicator 156e, or products on sale display words or phrases such as “sale”, “on sale”, “save $10”, or “half off” as the additional information indicator 156e.

If the selected product is also displayed in the collection region 148, a current status indicator 156f highlights the selected product in the collection. In some implementations, when the user selects a different item in the collection, the selection of that item is reflected by the current status indicator 156f highlighting the different product.

Some, all, or none of the product images are at least partly superimposed with one or more indicators 156g. In some implementations, the indicators 156g are used to draw the user's attention to particular items in the collection, such as items that are on sale, are on clearance, have newly arrived, receive free shipping, are available for pre-order, are most popular, have been recently discounted, or have other attributes that are to be brought to the user's attention. Some products displayed in the product selection region are also displayed with an availability indicator 156h. For example, if the product is available at a local retail outlet, the availability indicator 156h is made visible to the user and display a message such as “In stock at your local store”.

The product selection region 152 includes a collection of sorting and filtering controls 158a. By selecting various ones of the filtering controls 158a the user is able to alter the order in which items appear in the product browsing region 154 (e.g., priced low to high, priced high to low, alphabetically, ranked by popularity), or the user is able to control the subset of products displayed (e.g., members of a subcategory, only items that have been professionally reviewed, only items on sale).

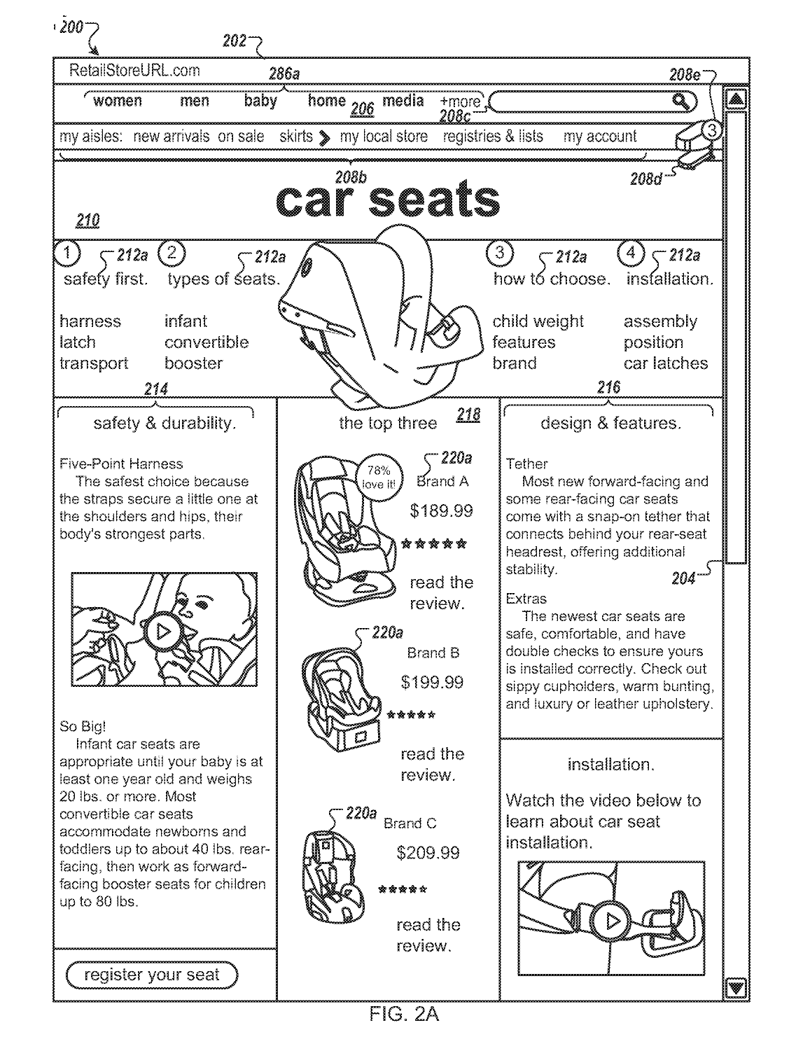

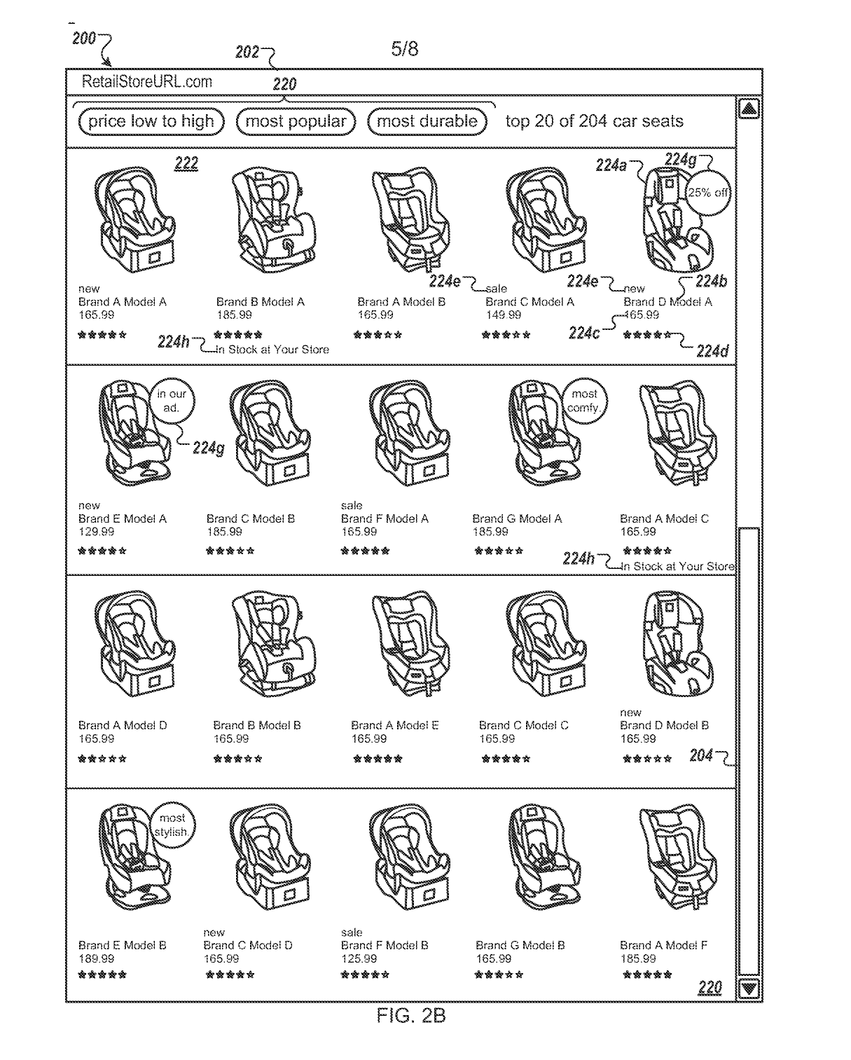

Referring now to FIGS. 2A and 2B, a web page 200 is displayed in a window 202 of a screen or display. In general, the web page 200 is laid out to be substantially the width of the window 202 and extends vertically. In some implementations, the web page 200 includes more information than can be conveniently displayed on the window 202 at one time. For example, a user uses a scroll bar 204 to shift the view of the web page 200 vertically. As can be seen in FIGS. 2A and 2B, the scroll bar 204 is illustrated in three different positions, corresponding to three different vertically located views of the web page 200.

The web page 200 includes a page header 206 substantially spanning the width of the web page 200. The page header 206 includes a collection of menu items 208a and a collection of menu items 208b. In some implementations, the user is able to select the menu items 208a-208b to link to other web pages or to activate the display of submenu items. An example submenu will be discussed in the description of FIG. 4.

A search input box 208c is provided for users to enter search strings. For example, the user types in keywords associated with a product he or she is seeking (e.g., “pencils”, “car seats”, “vacuum cleaners”) to activate a search routine that helps the user find what he or she is shopping for.

The user selects a shopping cart indicator 208d to display a list of items the user has already selected to purchase. A quantity indicator 208e is superimposed on the shopping cart indicator 208d. The quantity indicator 208e displays the quantity of items that the user has already selected for purchase (e.g., how many items are in the user's virtual shopping cart or bag). In some implementations, the quantity indicator 208e is displayed only when the user has selected one or more items for purchase (e.g., displayed only when the virtual shopping bag has something in it).

Below the page header 206 is a category description region 210. Generally speaking, the category description region 210 provides images and text that describe a product category. The category description region 210 includes a collection of shopping tips 212a. In some implementations, the shopping tips 212a provide advice that the user can consider when deciding which product to purchase from the displayed category of products.

A professional advice region 214 and a professional advice region 216 are located below the category description region 210. In some implementations, the professional advice regions 214-216 display text, images, and/or multimedia content from authoritative sources. For example, if the web page 200 generally displays information about infant car seats, then the professional advice regions 214-216 include information such as articles or videos from third party resources such as parenting magazines and websites.

A featured products region 218 is located below the category description region 210 and between the processional advice regions 214-216. The featured products region 218 displays a collection of featured products 220a that, in some implementations, can include image thumbnails, names, prices, ratings, or other information about featured products in the product category generally displayed by the web page 200. For example, the featured products region 218 displays the five most highly rated products in the current product category.

Referring now to FIG. 2B, the web page 200 includes a collection of sorting and filtering controls 220. By selecting various ones of the filtering controls 220 the user is able to alter the order in which items appear in a product browsing region 222 (e.g., priced low to high, priced high to low, alphabetically, ranked by popularity), or the user is able to control the subset of products displayed (e.g., members of a subcategory, only items that have been professionally reviewed, only items on sale).

The product browsing region 222 provides controls that allow the user to look at substantially all of the products available in the selected product's category. The product browsing region 222 displays an array of product images 224a, product descriptions 224b, prices 224c, and ratings indicators 224d. Some of the product descriptions 224b include an additional indicator 224e. For example, products that have recently been added to the collection display the word “new” as the additional information indicator 224e, and products on sale display “sale” as the additional information indicator 224e.

Some, all, or none of the product images are at least partly superimposed with one or more indicators 224g. In some implementations, the indicators 224g draw the user's attention to particular items in the collection, such as items that are on sale, are highly rated, are featured in recent advertisements, receive free shipping, are available for pre-order, are most popular, have been recently discounted, or otherwise have attributes that are to be brought to the user's attention. Selected products displayed in the product selection region are also displayed with an availability indicator 224h. For example, if the product is available at a local retail outlet, the availability indicator 224h will be visible to the user and display a message such as “In stock at your local store”.

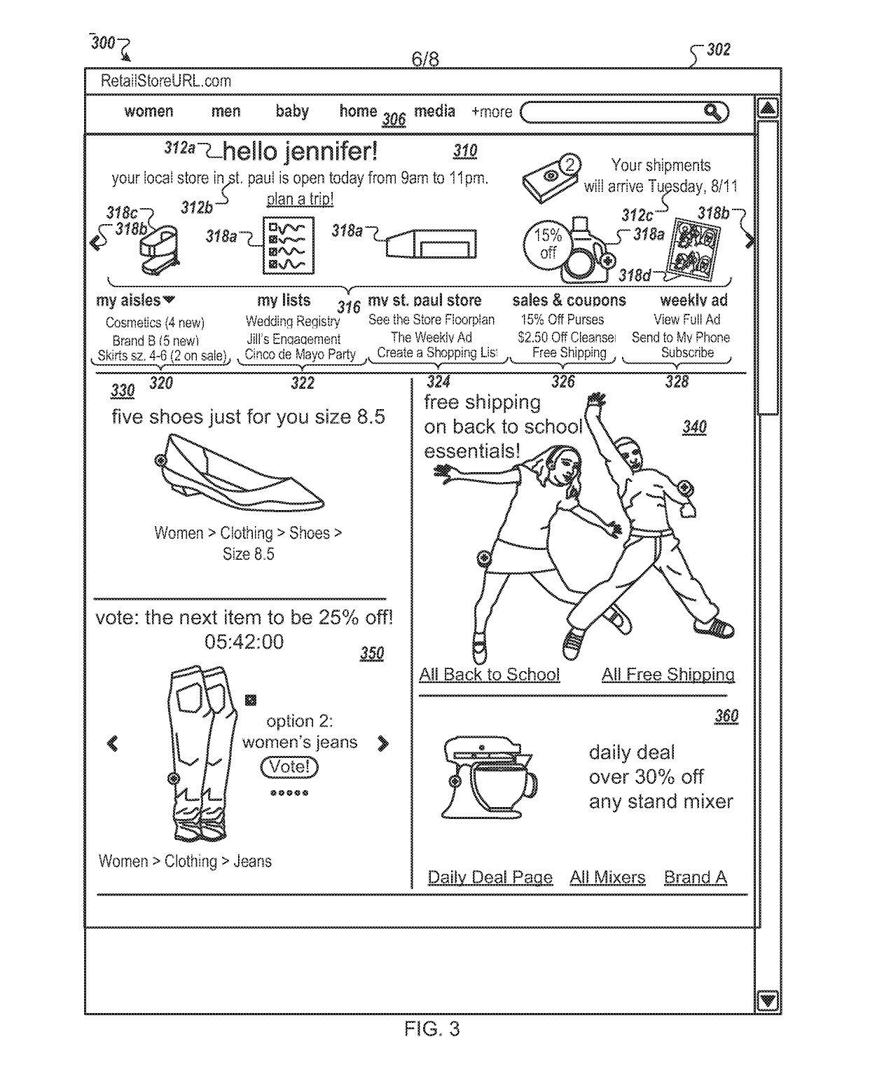

Referring now to FIG. 3, a web page 300 is displayed in a window 302. The web page 300 includes a page header 306 that is substantially similar to the page headers 106 and 206 of FIGS. 1A and 2A. Below the page header 306 is personalized region 310. In some implementations, the personalized region 310 includes messages and information that reflects the user's identity, the user's account information, information determined implicitly or explicitly about the user, or other information that is used give the user a more personalized shopping experience. For example, the personalized region 310 includes a personal greeting 312a, localization information 312b, and pending order information 312c.

Below the personalized region 310 is a product carousel region 316. The product carousel region 316 includes a collection of image thumbnails and product names 318a. In some implementations, the image thumbnails and product names 318a represent products that are of potential interest to the user. For example, the product carousel 316 includes a collection of products that are similar or complimentary to products the user has previously browsed or purchased. A pair of arrow controls 318b, when activated, cause the product carousel 316 to shift the collection of image thumbnails and product names 318a to the left or right in order to display additional product selections. A cart control 318c, when selected, links the user to a web page that displays a list of products the user has previously selected for purchase. A published ad control 318d, when selected, causes a substantial equivalent of the current local print ad to be displayed.

An aisles region 320, a lists region 322, a store region 324, a sales and coupons region 326, and a weekly ad region 328 are located in a row below the product carousel region 316. The aisles region 320 provides links to product categories that are of potential interest to the user. For example, the aisles region 320 displays links to product categories that the user has recently browsed or purchased from. The lists region 322 provides links to the user's lists, such as the user's wedding registry, a friend's baby registry, or other shopping lists. The store region 324 provides links to information about the user's local retail store. For example, the store region 324 includes links to the local store's weekly ad, driving directions, the store's floor plan, or other information. The sales and coupons region 326 provides links to discounts and other offers for various products. The weekly ad region 328 provides links to and relating to the store's weekly ad for the user's geographical location. For example, the user is able to click to see the weekly ad, send the ad to the user's phone, subscribe to electronic ad publications, or other information relating to advertisements.

A collection of marketing regions 330, 340, 350, and 360 are located below the row of regions 320-328. Each of the marketing regions 330-360 include marketing messaging that provides a brand experience, for example, through visually clean, timely promotions and offers that are potentially relevant to the user.

Referring now to FIG. 4, a web page 400 is shown displayed in a window 402 of a screen or other display. The web page 400 includes a page header 406 that is substantially similar to the page headers 106, 206, and 306. The page header 406 includes a collection of menu items 408. In some implementations, the user selects the menu items 408 to link to other web pages or to activate the display of submenu items. In the illustrated example, the user has selected one of the collection of menu items 408, and in response to the selection, a submenu 410 is displayed as a drop-down menu.

The submenu 410 includes a collection of subcategory items 412. In some implementations, the collection of subcategory items 412 provide links that let the user quickly navigate to various groupings of products that the user is shopping for. In the illustrated example, the user has selected a “baby” category and, in this example, the subcategories include bath items, bedding, diapers, food, and other such baby-related product categories. The submenu 410 also includes a collection of links 414 that, when selected, hyperlink the user to other web pages that are related to the selected product category. In the example of the baby category, the collection of links 414 includes links to items such as baby clearance items or a baby registry page.

The submenu 410 also includes a marketing space 416. The marketing space includes one or more images, such as the image 418, and/or the text 420. In some implementations, the marketing space 416 uses the image 418 and/or the text 420 to display marketing or monetization messages that are related to the selected category. Referring again to the example of the selected “baby” category, the marketing space 416 displays an announcement for a category-specific promotion such as free shipping when the user spends more than a predetermined amount on products in the selected category.

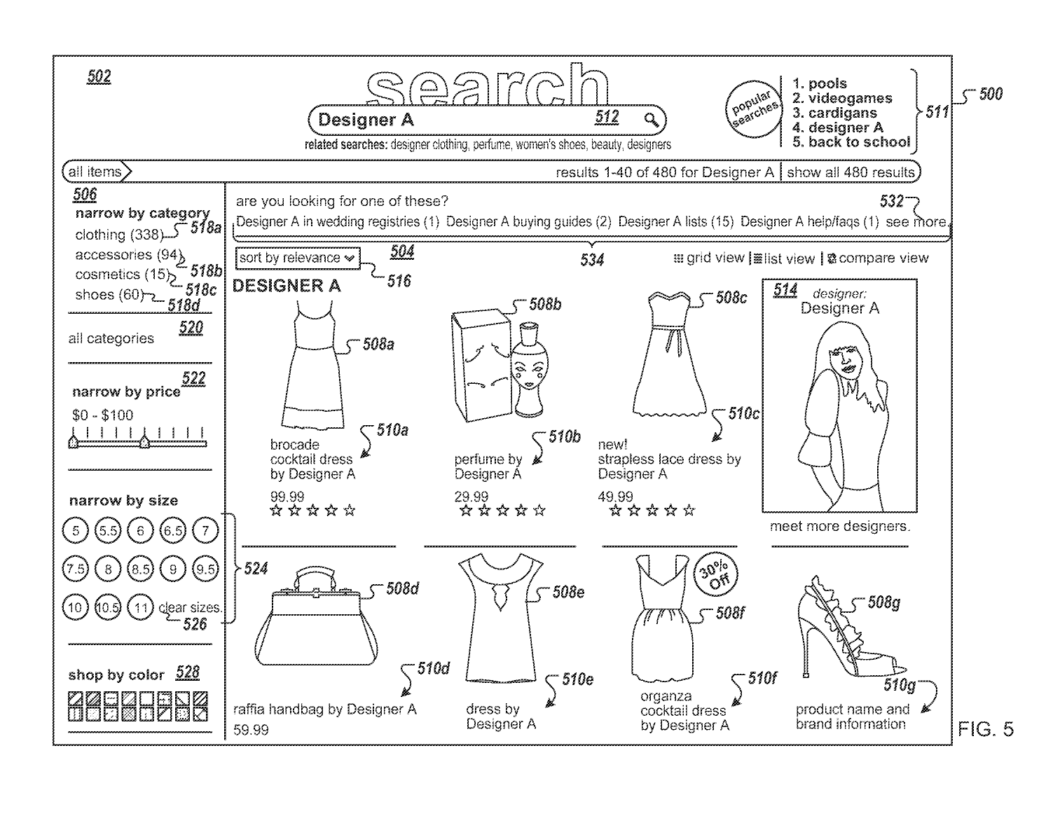

Referring now to FIG. 5, a web page 500 includes a search header 502. Below the search header 502 is search results region 504, including a series of thumbnail product images 508a through 508g with associated product information 510a through 510g, and a search narrowing region 506. The items displayed in the thumbnail product images 508a through 508g, for example, show a portion of search results received in response to a query for “Designer A” that has been submitted to a search input box 512 in the search header 502. A balloon indicator is partly superimposed over none, some, or all of the product images 508 to display additional information. For example, a balloon indicator 509 displays “30% off,” alerting the viewer to the fact that the product displayed in product image 508f is on sale.

The query used to produce the list of search results, for example, is typed into the search input box 512 or selected from a list of suggested searches 511 (e.g., most popular searches or recent searches) or a list of related searches 513 (e.g., keywords commonly correlated with one or more keywords last submitted in the search input box 512). In some implementations, the list of suggested searches 511 includes information relevant to the particular user. For example, the list of suggested searches 511 is based in part upon one or more factors such as the purchasing history of the user, the purchasing history of other users related to the user, the browsing history of the user, and the search input history of the user.

In the search results region 504, a designer information region 514 includes information regarding the designer “Designer A,” including a name and a photographic image. In some implementations, selection of the designer information region 514 provides the user with further information regarding the designer.

A user rearranges the search results presented in the search result region 504 by designating a results ranking method using a sort selection drop-down menu 516. For example, the selection “sort by relevance” is currently active in the sort selection drop-down menu 516. In some further examples, the sort selection drop-down menu 516 includes cost, user rating, and popularity.

Although the search results displayed in the search result region 504 are arranged in rows with four products per row, in some implementations, the user has the option of rearranging the search results into alternative search result layouts using a view layout control 517. For example, the user can select a list view, a grid view, or a comparison view through the view layout control 517.

In some implementations, the user chooses to filter the search results presented in the search region 504 using one or more of the tools presented in the search narrowing region 506. As illustrated, a set of product categories 518 present the user with selectable options for narrowing the search results by product category, including a clothing category 518a, an accessories category 518b, a cosmetics category 518c, or a shoes category 518d. If the user has already narrowed the search results to a particular category, the user selects an all categories option 520 to once again view search results related to all product categories.

A price selection control 522 allows the user to narrow the search results to a range of prices (e.g., $0 to $100, $40 to $80, etc.). The price selection control 522, in some implementations, varies in price range depending upon the price range available in the search results presented in the search results region 504.

A series of size selection controls 524 offers the user the opportunity to filter the search results to a particular garment size or range of garment sizes. In some implementations, the size selection controls 524 are activated upon selection of a relevant category. For example, once a user has selected either the clothing category 518a or the shoes category 518d, the size selection controls 524 are activated. The user then selects one or more of the size selection controls 524. After the user has narrowed the search results to one or more sizes, the user has the option to revert to a view of all available sizes using a clear sizes control 526.

A color selection control 528 provides the user with the opportunity to narrow the search results to one or more colors. For example, the user chooses a red box within the color selection control 528 to view only the red products within the search results presented in the search result region 504.

The search results region 504 includes a collection of additional resources links 530 associated with the search query entered in the search input box 512. As illustrated, the query “Designer A” has been associated with the following additional resource links: “Designer A in wedding registries,” “Designer A in buying guides,” “Designer A in lists,” and “Designer A help or frequently asked questions.” Each link, when selected, provides the user with one or more resources. A “see more” control 532, when selected, provides one or more further additional resource links 530.

In various implementations, the aspect ratio (height to width) of the web page is substantially greater than 1:1. In the example of FIGS. 1-2, the aspect ratio is about 3:1 or 4:1. In other embodiments, the aspect ratio is about 2:1 to about 10:1, more preferably about 3:1 to about 7:1, and even more preferably about 4:1 to about 6:1, and in one preferred embodiment about 5:1.

In various implementations, rich content is positioned “below the fold,” or below the bottom of the screen as the webpage is initially displayed to a user. FIGS. 1B, 1C, 2B and 2C depict content that is displayed below the fold, or below the bottom edge of the display of FIGS. 1A and 2A, respectively. The content displayed below the fold can be selected so as to draw consumers' attention below the fold. For instance, the thumbnail product arrays in FIG. 1 may encourage a consumer to scroll down, below the fold, if the consumer is looking primarily to review the products displayed in the thumbnail array. Such an approach can, in certain embodiments, have the effect of rendering the middle and bottom portions of the page more usable or valuable including in the sense that those regions will more likely be viewed by consumers.

The “fold” on a page will often be a function of the aspect ratio of the monitor on which the web page is displayed. The depicted displays have an aspect ratio of about 1:1. Monitors typically have an aspect ratio of about 1:1 or less, sometimes about 3:2 for wide-screen monitors.

A number of implementations have been described. Nevertheless, it will be understood that various modifications may be made without departing from the spirit and scope. For example, advantageous results may be achieved if the steps of the disclosed techniques were performed in a different sequence, if components in the disclosed systems were combined in a different manner, or if the components were replaced or supplemented by other components. The functions and processes (including algorithms) may be performed in hardware, software, or a combination thereof, and some implementations may be performed on modules or hardware not identical to those described. Accordingly, other implementations are within the scope of the following claims.

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. A computer-implemented method of rendering a web page of a retailer, the computer-implemented method including the step of:
operating one or more computers to serve one or more files to create and display a web page of a retailer on an electronic display, the web page including:
a first region including a search input box for receiving a search query of a user, the search input box including a search activation member that when activated by a user will cause a search to be performed for product information corresponding to the search query;
a second region below the first region, the second region having a search results display area for displaying results of the search query of the user, the search results display area being configured to display product information for a plurality of products corresponding to the search query of the user, the product information includes a pictorial image of a product, product pricing and one of a customer rating and a product description, the second region further including at least one of a search sorting control and a display view control, the search sorting control being configured to allow a user to customize order of appearance of the results of the search query displayed in the search results display area based on a plurality of different search sorting criteria, the plurality of different search sorting criteria including at least relevance, product cost and product popularity, the display view control being configured to allow a user to select from a plurality of different views to display the product information in the search results display area, the plurality of different views including a grid view displaying product information in a plurality of rows in the second region and a list view displaying product information in a vertical column with product information for a first product displayed directly above product information for a second product; and,
a third region including at least one search narrowing control for narrowing search results displayed in the search results display area without entering a new search query in the search input box, the third region being horizontally aligned with the second region and disposed below the first region, the search narrowing control including at least a first search narrowing criteria and a second search narrowing criteria where the first search narrowing criteria is different from the second search narrowing criteria.

13. The method claim 12, wherein one of the search sorting control and the display view control is a drop-down menu.

14. The method of claim 13, wherein the search results display area includes a search sorting control, the search sorting control is a drop-down menu that upon activation presents the user with the relevance search sorting criteria, the product cost search sorting criteria and the product popularity search sorting criteria.

15. The method of claim 14, wherein the drop-down menu is disposed above the product information.

16. The method of claim 12, wherein the first region includes a search results summary identifying a number of search results displayed on the web page at a given time and a total number of search results developed from the search query.

17. The method of claim 12, wherein the display view control includes at least one other view different from the grid view and the list view.

18. The method of claim 12, wherein the display view control further includes a compare view.

19. A computer-implemented method of rendering a web page of a retailer, the computer-implemented method including the step of:
operating one or more computers to serve one or more files to create and display a web page of a retailer on an electronic display, the web page including:
a first region including a search input box for receiving a search query of a user, the search input box including a portion in which a user can enter a search query;
a second region below the first region, the second region having a search results display area for displaying results of the search query of the user, the search results display area being configured to display product information for a plurality of products corresponding to the search query of the user, the second region further including a search sorting control and a display view control, the search sorting control being configured to allow a user to customize order of appearance of the results of the search query displayed in the search results display area based on a plurality of different search sorting criteria, the display view control being configured to allow a user to select from a plurality of different views to display the product information in the search results display area; and,
a third region including at least one search narrowing control for narrowing search results displayed in the search results display area without entering a new search query in the search input box, the third region being disposed below the first region, the search narrowing control including at least a first search narrowing criteria which when activated by the user will narrow search results of the search query displayed in the second region.

20. The method claim 19, wherein one of the search sorting control and the display view control is a drop-down menu.

21. The method of claim 19, wherein the search sorting control is a drop-down menu that upon activation presents the user with a relevance search sorting criteria, a product cost search sorting criteria and a product popularity search sorting criteria.

22. The method of claim 19, wherein the at least one search narrowing control includes at least two of the following search narrowing criteria: (i) a product category search narrowing criteria; (ii) a product price search narrowing criteria; (iii) a product size search narrowing criteria and (iv) a product color search narrowing criteria.

23. The method of claim 19, wherein the at least one search narrowing control includes a product category search narrowing criteria, a product price search narrowing criteria and a product size search narrowing criteria.

24. The method of claim 23, wherein the first region includes a search results summary identifying a number of search results displayed on the web page at a given time and a total number of search results developed from the search query.

25. The method of claim 19, wherein the display view control is horizontally aligned with the search sorting control.

26. The method of claim 25, wherein the display view control and the search sorting control are disposed above the product information.

27. A computer-implemented method of rendering a web page of a retailer, the computer-implemented method including the step of:
operating one or more computers to serve one or more files to create and display a web page of a retailer on an electronic display, the web page including:
a first region including a search input box for receiving a search query of a user, the search input box including a search activation member that when activated by a user will cause a search to be performed for product information corresponding to the search query;
a second region below the first region, the second region having a search results display area for displaying results of the search query of the user, the search results display area being configured to display product information for a plurality of products corresponding to the search query of the user, the product information includes a pictorial image of a product, product pricing and one of a customer rating and a product description, the second region further including a search sorting control and a display view control, the search sorting control being configured to allow a user to customize order of appearance of the results of the search query displayed in the search results display area based on a plurality of different search sorting criteria, the plurality of different search sorting criteria including at least relevance, product cost and product popularity, the display view control being configured to allow a user to select from a plurality of different views to display the product information in the search results display area, the plurality of different views including at least three different views; and,
a third region including at least one search narrowing control for narrowing search results displayed in the search results display area without entering a new search query in the search input box, the third region being horizontally aligned with the second region and disposed below the first region, the search narrowing control including at least a first search narrowing criteria, a second search narrowing criteria and a third search narrowing criteria where the first search narrowing criteria, the second search narrowing criteria and the third search narrowing criteria are each different search narrowing criteria.

28. The method of claim 27, wherein the product information includes a customer rating.

29. The method of claim 27, wherein the first search narrowing criteria is a product category search narrowing criteria.

30. The method of claim 27, wherein the third region includes a clear search narrowing control member for clearing at least one previously activated search narrowing criteria such that the product information displayed in the search results display area returns to the product information displayed just prior to activation of the search narrowing criteria.

31. The method of claim 27, wherein the first region extends substantially the width of the web page and the second region has a width substantially greater than a width of the third region.
